(19) United States
(12) Patent Application Publication
(10) Pub. No.: US 2013/0276010 A1
(43) Pub. Date: Oct. 17, 2013

(54) CONTENT SERVING

(71) Applicant: Timbo Drayson, London (GB)

(72) Inventor: Timbo Drayson, London (GB)

(21) Appl. No.: 13/795,615

(22) Filed: Mar. 12, 2013

Related U.S. Application Data
(60) Provisional application No. 61/623,370, filed on Apr. 12, 2012.

(51) Int. Cl. H04N 21/442

(52) U.S. Cl. CPC H04N 21/44222
USPC 725/14; 725/32

(57) ABSTRACT

A processor-implemented method for serving second content segments to a second media device based on first content segments displayed on a first media device includes receiving an identification of a first content segment; receiving a synchronization signal indicating synchronization between the first and the second media devices; identifying a producer of the first content segment; sending a content segment request to the identified producer and one or more additional producers; when a satisfactory response to the request is received at the processor, selecting a second content segment to serve to the second media device; and when a satisfactory response is not received at the processor, auto generating a substitute second content segment, and serving the substitute second content segment to the second media device.

### PRIORITY

This application claims the benefit of provisional patent application Ser. No. 61/623,370 filed Apr. 12, 2012, entitled “Advertisement Serving System and Method.” This provisional application is hereby incorporated by reference in its entirety.

### BACKGROUND

Conventional television program distribution systems include, by way of example, cable television systems, satellite television systems, and systems providing Internet protocol television (iTV) over digital subscriber line (DSL) or fiber. Such systems are configured to distribute media streams associated with subscription television services to system subscribers or other users. Typically, a given subscriber is provided with an interface device, such as a set-top box or receiver, for communicating with system head end equipment. The interface device is configured to permit the subscriber to receive, on a television or other presentation device coupled to the interface device at a given location, the particular subscription television services to which that subscriber is entitled by virtue of the subscription. A given subscription may encompass a number of basic broadcast channels, as well as one or more premium programming channels, such as movie channels, sports channels, specialty channels, pay-per-view channels, and on-demand video channels.

Sponsors use the television program distribution systems to serve sponsored content to subscribers, and such sponsored content provides effective brand advertising. However, sponsors may find it difficult to measure the effectiveness of their sponsored content and to get subscriber to act on a call to action.

### DESCRIPTION OF THE DRAWINGS

The detailed description will refer to the following drawings, in which like numerals refer to like items, and in which:

FIG. 1 illustrates an embodiment of an environment in which sponsored content segments are served to a second media device;

FIG. 2 illustrates an embodiment of hardware components that support serving sponsored content segments to a second media device;

FIG. 3 is a block diagram of an example of a software system that supports serving sponsored content segments to a second media device; and

FIG. 4 is a flowchart illustrating an example of a method for serving sponsored content segments to a second media device.

### DETAILED DESCRIPTION

At a television viewing location, which may be a home, a business, or a public facility or means of conveyance, a first media device may receive and display content (e.g., a television program) in which are inserted, or otherwise served, sponsored content segments (referred to hereafter as advertisements). A second media device (which may be a television or a mobile viewing device, for example) at the same viewing location may serve an advertisement based on an advertisement served on the first viewing device. More specifically, when an advertisement is displayed on the first media device, the first media device may notify a remote service system, which will then identify the advertisement and its advertiser, and solicit a “second screen” advertisement by, for example, a bidding process, from the advertiser, or other advertisers, or may auto-generate a second screen advertisement. The second screen advertisement, if any, then is served to the second media device. This allows television advertisers to serve a complimentary advertisement to their television advertisement to an individual operating or viewing the second media device.

The determination of which advertisements to serve with which program may depend in part on information related to an individual viewing the program. This information may be provided by the individual voluntarily. For example, an individual may register with a sponsor or otherwise agree to provide information such as a password and user ID. In situations in which the systems disclosed herein collect personal information about individuals, or may make use of personal information, the individuals may be provided with an opportunity to control whether programs or features collect individual information (e.g., information about an individual's social network, social actions or activities, profession, an individual's preferences, or an individual's current location), or to control whether and/or how to receive advertisements that may be more relevant or of interest to the individual. In addition, certain data may be treated in one or more ways before it is stored or used, so that personally identifiable information is removed. For example, an individual's identity may be treated so that no personally identifiable information can be determined for the individual, or an individual's geographic location may be generalized where location information is obtained (such as to a city, ZIP code, or state level), so that a particular location of an individual cannot be determined. Thus, the may have control over how information is collected about the individual and used by a server.

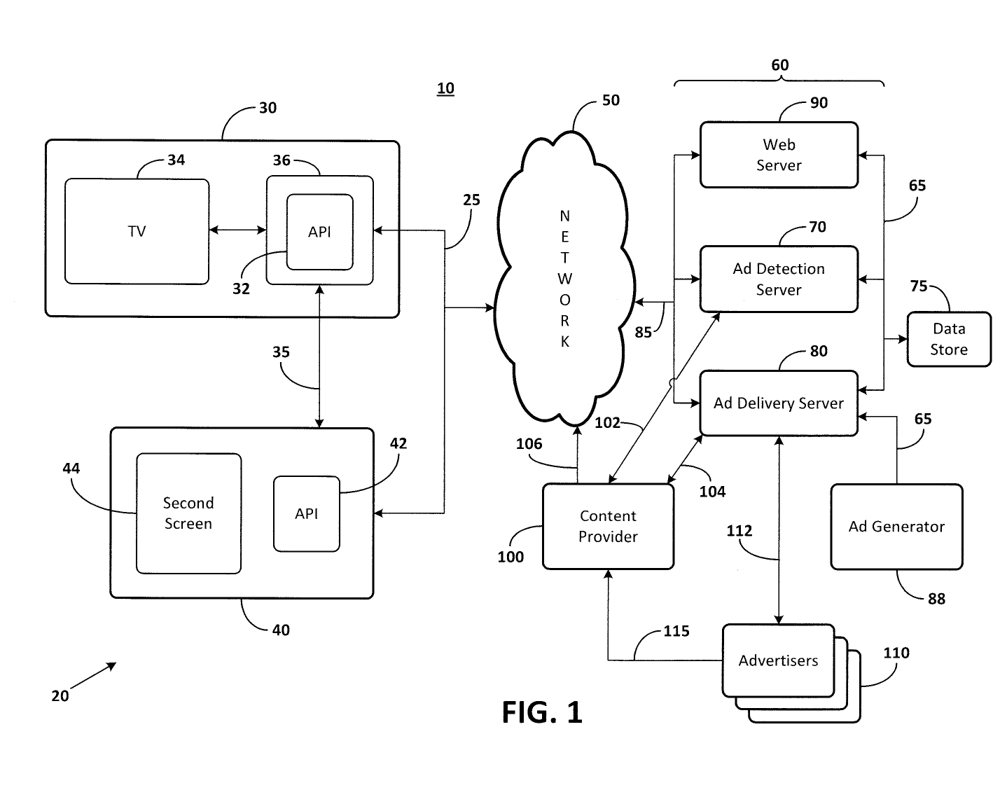

FIG. 1 illustrates an embodiment of an environment in which advertisements are served at a second media device. In FIG. 1, environment 10 includes viewing location 20 connected to remote server system 60 and content provider 100 through network 50. Connected to the server system 60 are advertisers 110.

The content provider 100 may provide content (106) for delivery to the media devices 30 and 40. The content provider 100 also may provide content (102, 104) to the ad detection server 70 and the ad delivery server 80. The content 102 and 104 may be used by the server system 60 components to monitor content so as to determine when an advertisement is displayed on the media device 30, and to specifically identify the advertisement and its associated advertiser. Although the content provider 100 is shown sending data directly (i.e., through a dedicated or private network) to the server system 60, such information also may be sent using the network 50.

Advertisers may develop advertisements for display at the media devices 30 and 40. The advertisements may be sent (115) to the content provider 100 and/or (112) to the ad delivery server 80. The advertisements may include those intended for display on the media device 30. The advertisements also may include those intended for display on the media device 40 in response to advertisements displayed on the media device 30. This latter category of advertisements will be referred to hereinafter as second screen advertisements, because such advertisements are displayed on the media device 40 (i.e., the second screen) in response to advertisements displayed on the media device 30 (i.e., the first screen).

The viewing location 20 is a location at which an individual or a subscriber is permitted to access one or more television services. The viewing location 20 may be a room in a house, a hotel room, a business facility including a bar, a train, airplane, car, bus, boat or ship, or a public area such as a lounge at an airport. Access to these television services may be by way of a subscription. Alternately, access may be free, such as in the case of traditional over-the-air broadcasts. As used herein, an individual is a human, and use of the singular “individual” should be understood to encompass multiple individuals (e.g., a family). A subscriber is used herein is to encompass subscribing entities, such as businesses or organizations, in addition to individuals or groups of individuals.

An individual at the viewing location 20 is able to view and interact with both the media devices 30 and 40. As shown in FIG. 1, the media device 30 is a “basic” television 34 that is coupled to a program receiving unit 36 equipped with a separate processor, such as a set top box (STB) or satellite box. In an alternative, the media device 30 is an Internet-connected “smart” television (iTV). In another alternative, the media device 30 is an iTV coupled to a program receiving unit such as a Blu-ray™ box, a game box, and an Internet television box. Other configurations for the media device 30 are possible. The media device 40 is illustrated as an iTV having a display 44. The media device 40 may be, in an alternative, a mobile device such as a tablet, smart phone, lap top computer, or other mobile or portable device. The media device 40, in another alternative, is a desktop computer or other static device. The media device 40 and the media device 30 are capable of communicating with each other over communications path 35. Communications path 35 can be wired or wireless, and includes WiFi, infrared, and “broadcast.” Otherwise, the media devices 30 and 40 are “independent” of each other; that is, the operation of one does not depend on the operation of the other. However, each of the media devices 30 and 40 may include synchronizer APIs—synch API 32 and synch API 42, respectively. The synch APIs 32 and 42 synchronize the media devices 30 and 40 so that the media device 30 may “know” what content is being displayed on the media device 40 and the media device 40 may “know” what content is being displayed on the media device 30. The synch APIs 32 and 42 may, in an example, access a reference signal emanating from the provider of the content being displayed on the media devices 30 and 40.

The media devices 30 and 40 are coupled to network 50, which may be any communications network that allows the transmission of signals, media, messages, voice, and data to the viewing location 20, including radio, linear broadcast (over-the-air, cable, and satellite) television, on-demand channels, over-the-top media, including streaming video, movies, video clips, and games, and text, email, and still images, and transmission of signals, media, messages, voice, and data from the media devices 30 and 40. The network 50 may include local networks, wide area networks, and the Internet, for example.

The server system 60 includes ad detection server 70, ad data store 75, ad detection server 80, and ad generator 88. The components may communicate amongst each other using local area network 65, and may communicate with media devices at the viewing location 20 using network 85.

Within the server system 60, the ad detection server 70 operates to detect advertisements displayed on the media device 30 and to identify the advertiser associated with a detected advertisement. The ad delivery server 80 functions to deliver advertisements to the media device 40 based on advertisements displayed on the media device 30. The ad generator 88 operates to automatically generate advertisements based on information received at the ad detection server 70 and the ad delivery server 80. This automatic ad generation feature is described later. The Web server 90 provides Internet-based content to the media devices 30 and 40.

The ad detection server 70 may require specific information from the media device 30 in order to detect an advertisement being displayed at the media device 30. One detection mechanism involves the media device 30 sending programs currently watched information to the server system 60. For example, where the media device 30 is a television, or a control box (e.g., a set top box) coupled to a television, the media device 30 may send channel information to the ad detection server 70, where the channel information includes the channel to which the media device 30 is tuned. The channel information, combined with time and date information available to the ad detection server 70 may be sufficient to allow the ad detection server 70 to determine what advertisements are displayed at the media device 30. That is, the ad detection server 70 may monitor broadcast television programming (e.g., from content provider 100), and when the ad detection server 70 receives the channel information from the media device 30, the ad detection server 70 may determine, by virtue of such monitoring, which advertisement is currently being displayed at the media device 30.

Once the ad detection server 70 detects a specific advertisement, the ad detection server 70 may identify the advertiser that supplied the specific advertisement. To identify the advertiser, the ad detection server 70 may access a database (not shown) that maps advertisements to advertisers. The ad detection server 70 then may send the identity of the advertisement currently being watched at the media device 30, and the identity of the advertiser, to the ad delivery server 80.

The ad delivery server 80 operates to select and serve an advertisement to the media device 40 based on the supplied advertisement and advertiser information from the ad detection server 70. In selecting the advertisement, the ad delivery server 80 may serve one of two different advertisements types. A first advertisement type is an advertisement submitted by the advertiser that was identified by the ad detection server 70. A second advertisement type is an advertisement that is automatically generated by another service, such as the ad generator 88.

The first advertisement type may be an advertisement intended for specific types of the second media device 40. For example, a tablet may be served with a first advertisement that is different from a first advertisement type that is served to an iTV. Furthermore, the first advertisement types may vary depending on a specific manufacturer of the second media device 40. The first advertisement types also may vary based on different subscription services (e.g., satellite television versus cable television).

The advertiser may designate or identify several advertisements that would be categorized as first advertisement type. The advertiser may provide this identity and the creatives to the server system 60, where the identities and creatives are stored, in data store 75, for possible delivery to the media device 40.

When the components of the server system 60 identify a displayed advertisement, and the associated advertisement, logic in the ad delivery server 80 may cause the ad delivery server 80 to indicate to the advertisers 110 that an advertising opportunity exists to supply a second screen advertisement to the media display device 40. for example, if the media device 30 is displaying an advertisement for a German sports car, the ad detection server 70 may identify the advertisement, and the car manufacturer, and supply this information to the ad delivery server 80. The ad delivery server 80 may notify the advertisers 110 that a second screen advertisement opportunity exists. Alternately, the ad delivery server 80 may notify only the car manufacturer that a second screen advertisement opportunity exists. In either case, the ad delivery server 80 may open a round of bidding to see if, in an example, any one of the advertisers 110 would like to bid on and purchase a second screen advertisement, or, in another example, the car manufacturer specifically would like to bid on and purchase a second screen advertisement. In the first example mentioned above, the advertiser 110 with the highest bid may be selected to serve a second screen advertisement to the media device 40. In the second example, if the car manufacturer submits a bid, and the bid is not high enough (either not the highest bid, or not above a minimum bid threshold), then the car manufacturer would not serve the second screen advertisement.

In the event there are no bids, or in the event that the submitted bid(s) are not high enough, the ad delivery server 80 may direct the ad generator 88 to generate an advertisement for display on the media device 40. The ad generator 88 may start with a basic advertisement format or template and “build” an advertisement using, for example, the information received by the ad detection server 70. Thus, if the advertiser 110 does not submit a second screen advertisement, or there are no bids for a second screen advertisement, the ad generator may build, and the ad delivery server 80 serve, an advertisement of the second type.

However determined, the second screen advertisement may be served by the ad delivery server 80 to the media device 40. Alternately, the advertisers 110 may serve the advertisement directly to the media device 40. The format and content of the served advertisement may not be changed based on a specific delivery mechanism.

An individual operating the media device 40 may interact with the served second screen advertisement. For example, the second screen advertisement may include a link to a Web site, and the individual may use the link to access the Web site. Such an interaction may be recorded at the media device 40, and the media device 40 may send relevant information of this interaction to the service system 60 for ultimate delivery to the advertiser 110. Other interactions include providing feedback concerning an advertisement, or the advertised product or service, calling a phone number listed in the advertisement, asking to be contacted (email, phone) about a product or service, and sending an email to the service system 60.

The herein disclosed systems and methods also may be used to serve advertisements to the first media 30. device based on advertisements served on the second media device 40.

In an alternative, the first media device 30 displays content that is not being broadcast or streamed, such as a pay-per-view movie, or a video game. The service system 60 still may track the progress of these different media types, and serve an ad to the second media device 40. For example, a video game may display an advertisement at a specific point in the display of the video game. As long as the components of the service system 60 can determine that the advertisement is being displayed on the first media device 30, the components may identify and serve a complimentary “second screen” advertisement on the second media device 40.

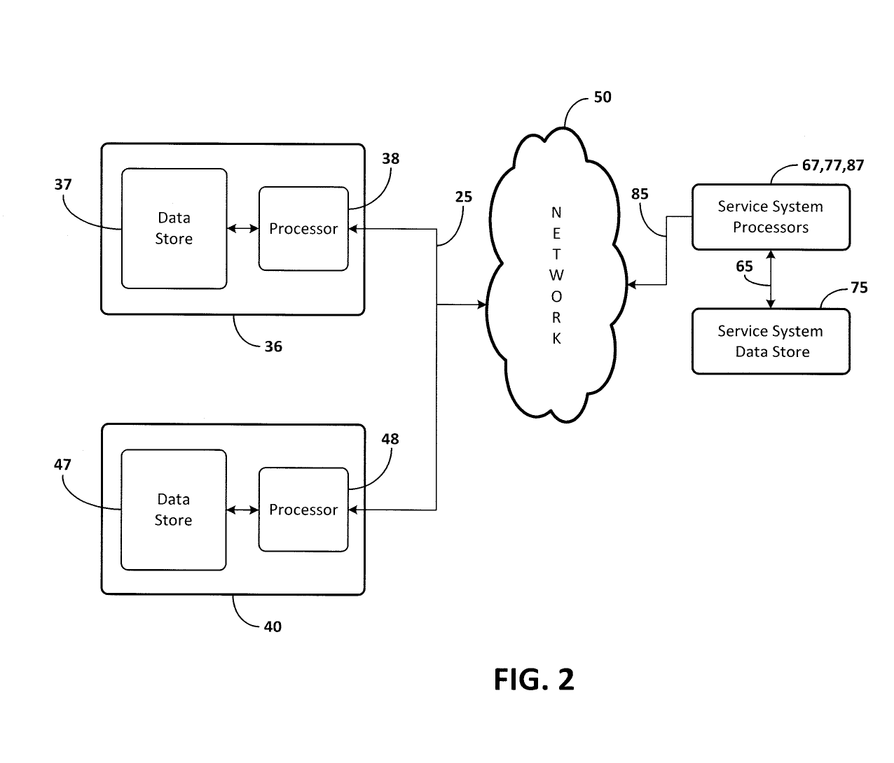

FIG. 2 illustrates an embodiment of hardware components that support serving of advertisements to a second media device. FIG. 2 illustrates the program receiving unit 36 (of media device 30) includes data store 37 and processor 38. Media device 40 includes data store 47 and processor 48. The APIs 32 and 42 (see FIG. 1), as well as other machine executable instructions may be stored in the data stores 37 and 47, respectively, which are non-transitory computer readable storage mediums, and the machine executable instructions may be executed by the processors 38 and 48, respectively.

Software components of service system 60 may be stored on data store 75. The service system components may be executed by processors 67, 77, and 87, which are coupled to data store 75. That is, the data store 75 includes machine executable instructions that may be executed by the processors 67, 77, and 87. The data store 75 is a non-transitory computer readable storage medium.

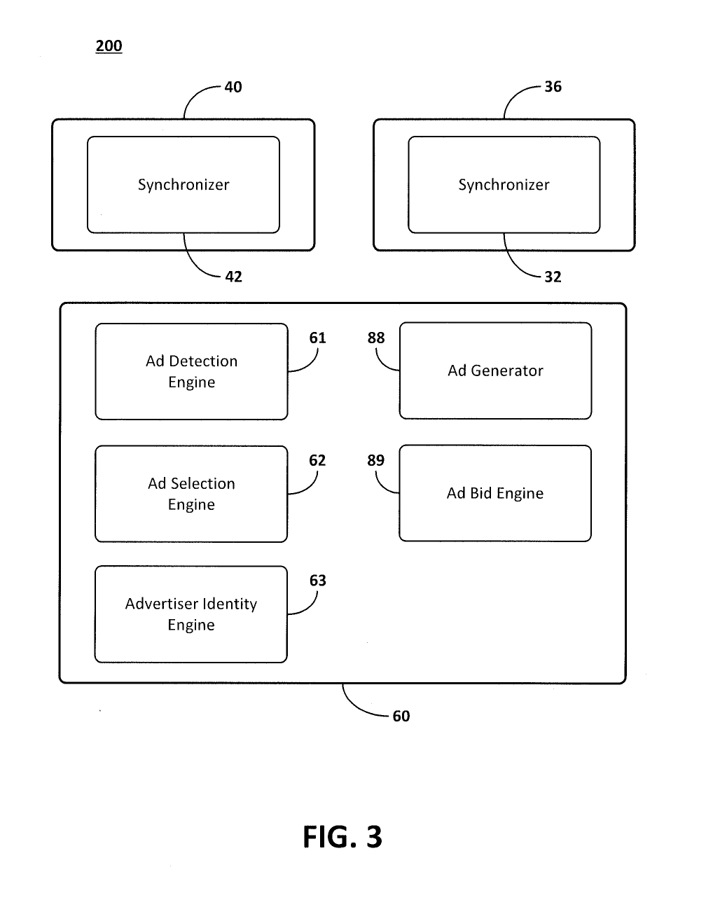

FIG. 3 is a block diagram of an example of software components of service system 60, which supports serving of second screen advertisements to a second media device. In FIG. 3, service system 60 software components communicate with synchronizer 42 that is stored on media device 40 and synchronizer 32 that is stored on program receiving unit 36.

As shown in FIG. 3, the service system 60 software components include ad detection engine 61, ad selection engine 62, advertiser identity engine 63, ad generator 88, and ad bid engine 89. These software components support operations as described above with respect to FIG. 1.

More specifically, the ad detection engine 61 when executed by a processor such as the processor 67 (see FIG. 2) may acquire, in an embodiment, information from the media devices 30 and 40 and may use this acquired information to determine an advertisement being displayed at the media device 30. One detection mechanism involves the media device 30 sending programs currently watched information to the server system 60. For example, where the media device 30 is a television, or a control box (e.g., a set top box) coupled to a television, the media device 30 may send channel information to the system 60, where the channel information includes the channel to which the media device 30 is tuned. The channel information, combined with time and date information available to the ad detection engine 61 may be sufficient to allow the ad detection engine 61 to determine which advertisements are displayed at the media device 30. In an aspect, the ad detection engine 61 may monitor broadcast television programming (e.g., from content provider 100), and when the ad detection engine 61 receives the channel information from the media device 30, the ad detection engine 61 may determine, by virtue of such monitoring, which advertisement is currently being displayed at the media device 30.

The advertiser identity engine 63 when executed by the processor 67 may identify an advertiser that supplied a specific advertisement as identified by the ad detection engine 61. To identify the advertiser, the advertiser identity engine 63 may access a database (not shown) that maps advertisements to advertisers. The engine 61 then may send the identity of the advertisement currently being watched at the media device 30, and the identity of the advertiser, to the ad selection engine 62.

The ad selection engine 62 may select an advertisement to serve on a second screen (media device 40) based on an advertisement displayed on a first screen (media device 30). The second screen advertisement may be provided by the advertiser identified by the advertiser identity engine 63, or by other advertisers. In one aspect, the ad selection engine 62 may interface with the ad bid engine, which operates an ad auction system, with the advertisement to be served having a winning auction bid (e.g., a highest bid). If no bids are received, or in the event that the received bids do not meet a minimum threshold value, the engine 62 may direct the ad generator 88 to generate an advertisement for display on the second screen.

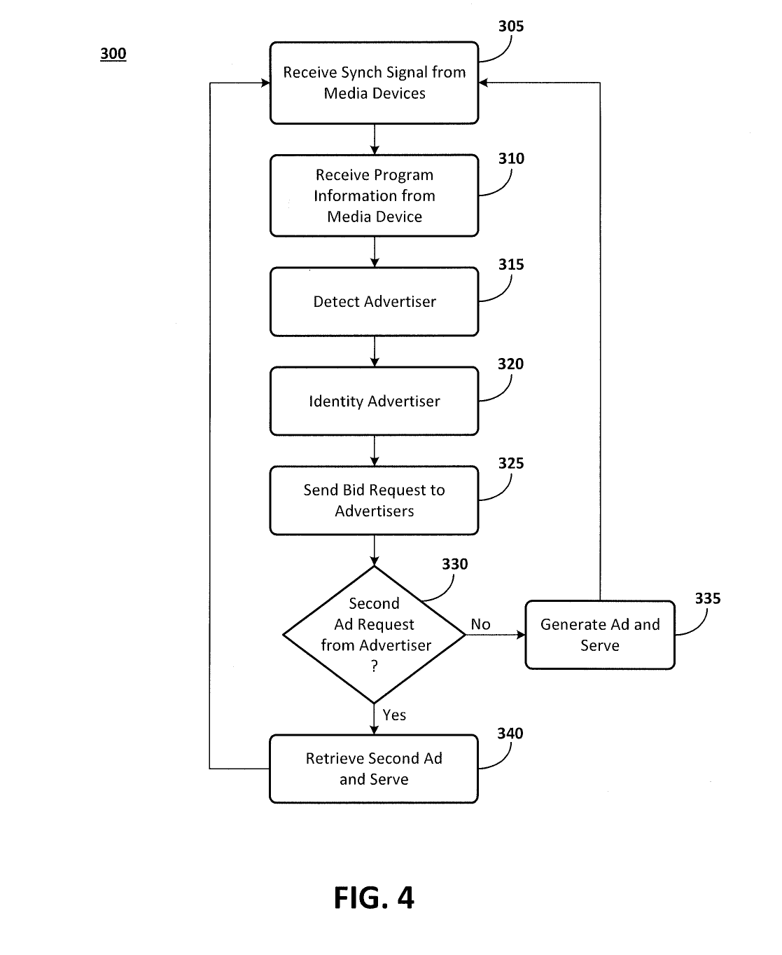

FIG. 4 is a flowchart illustrating an example for a method for serving second screen advertisements at a second media device. In FIG. 4, method 300 begins, block 305, when the service system 60 receives a synchronization signal from the media device 30, indicating the media devices 30 and 40 are synchronized and providing a time basis to the service system 60. In block 310, the service system 60 receives program information, such as the tuned channel, from the media device 30. In block 315, with the ad detection server 70, synchronized to the media device 30, and monitoring the programming displayed on the media device 30, detects an advertisement. The advertisement server 70 then identifies the advertisement, and in block 320, identifies the advertiser. In block 325, the ad delivery server 80 generates a second screen advertisement bid and posts the bid for response from the advertisers, and from other advertisers. In block 330, the ad server 80 determines if a bid has been received, and if the bid is from the advertiser. If a bid is not received, the method 300 moves to block 335, and the ad generator 88 generates, and the ad delivery server 80 serves, an auto-generated advertisement to the media device 40. If the advertisers bids and wins, the method 300 moves to block 340 and the ad server 80 retrieves and serves a designated second screen advertisement to the media device 40. Following either block 335 or 340, the method 300 returns to block 305.

Certain of the devices shown in the herein described figures include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAM) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a flow chart and accompanying description to illustrate the embodiments represented in FIG. 4. The disclosed devices, components, and systems contemplate using or implementing any suitable technique for performing the steps illustrated. Thus, FIG. 4 is for illustration purposes only and the described or similar steps may be performed at any appropriate time, including concurrently, individually, or in combination. In addition, many of the steps in the flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on computer storage medium for execution by one or more processors. A computer storage medium can be, or can be included in, a computer-readable storage device, a computer-readable storage substrate, or a random or serial access memory. The computer storage medium can also be, or can be included in, one or more separate physical components or media such as multiple CDs, disks, or other storage devices. The computer readable storage medium does not include a transitory signal.

The herein disclosed methods can be implemented as operations performed by a processor on data stored on one or more computer-readable storage devices or received from other sources.

A computer program (also known as a program, module, engine, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

I claim:

1. A method, implemented by a processor, for serving advertisements, comprising:
receiving, by a processor, from a first media device, program information from an advertisement displayed on the first media device, the program information identifying advertisements displayed on the first media device, and a time synchronization signal from the first media device, the signal usable to indicate synchronization between the first media device and a second media device;
identifying, by the processor, a first advertisement displayed on the first media device;
identifying, by the processor, an advertiser associated with the identified first advertisement;
sending an ad request to a plurality of advertisers;
receiving, by the processor, an advertising bid from one or more advertisers including the identified advertiser for serving an advertisement on the second media device;
when an advertiser submits a satisfactory bid, serving, by the processor, a second advertisement to a second media device in synchronization with the first media device; and
when no advertiser submits a satisfactory bid, producing, by the processor, an auto-generated second advertisement, and serving the auto-generated advertisement to the second media device.

2. The method of claim 1, wherein the second advertisement is complimentary to the first advertisement.

3. The method of claim 1, further comprising:
monitoring, by the processor, broadcast programming available to the first media device; and
comparing, by the processor, the received program information and the time synchronization signal to the monitored programming to identify the first advertisement.

4. The method of claim 1, wherein the satisfactory bid is above a minimum threshold value.

5. The method of claim 4, wherein the advertiser submitting the satisfactory bid is the identified advertiser.

6. The method of claim 4, wherein the satisfactory bid is a highest bid.

7. The method 6, wherein the advertiser submitting the highest bid is the identified advertiser.

8. The method of claim 1, wherein sending the ad request comprises sending, by the processor, the ad request only to the identified advertiser.

9. The method of claim 1, wherein the second advertisement includes a link to an external resource, the method further comprising:
detecting, by the processor, activation of the link at the second media device; and
sending information related to the link activation to the advertiser serving the second advertisement.

10. An advertisement serving system, comprising:
a processor; and
a computer readable storage medium having embedded thereon a program of machine instructions executable by the processor, wherein when executed, the instructions cause the processor to:
receive information from a first media device, the information identifying advertisements displayed on the first media device, and a time synchronization signal from the first media device, the signal usable to indicate synchronization between the first media device and a second media device;
identify a first advertisement displayed on the first media device;
identify an advertiser associated with the identified first advertisement;
send an ad request to a plurality of advertisers;
receive a bid from one or more advertisers including the identified advertiser for serving an advertisement on the second media device;
when an advertiser submits a satisfactory bid, serve a second advertisement to a second media device in synchronization with the first media device; and
when no advertiser submits a satisfactory bid, produce an auto-generated second advertisement and serve the auto-generated advertisement to the second media device.

11. The system of claim 10, wherein the processor:
monitors content available to the first media device; and
compares the received program information and the time synchronization signal to the monitored content to identify the first advertisement.

12. The system of claim 10, wherein the advertiser submitting the satisfactory bid is the identified advertiser.

13. The system of claim 10, wherein processor sends the ad request only to the identified advertiser.

14. The system of claim 10, wherein the second advertisement includes a link to an external resource, and the processor:
detects activation of the link at the second media device; and
sends information related to the link activation to the advertiser serving the second advertisement.

15. The system of claim 10, wherein the content is broadcast television programming.

16. The system of claim 10, wherein the content is a game executed by the first media device.

17. The system of claim 16, wherein the game is accessed by the first media device from a site external to the first media device.

18. The system of claim 16, wherein the game is accessed by the first media device from a site internal to the first media device.

19. A processor-implemented method for serving second content segments to a second media device based on first content segments displayed on a first media device, comprising:
receiving, by the processor, an identification of a first content segment;
receiving, by the processor, a synchronization signal indicating synchronization between the first and the second media devices;
identifying, by the processor, a producer of the first content segment;
sending, by the processor, a content segment request to the identified producer and one or more additional producers;
when a satisfactory response to the request is received at the processor, selecting a second content segment to serve to the second media device; and
when a satisfactory response is not received at the processor:
auto generating, by the processor, a substitute second content segment, and
serving the substitute second content segment to the second media device.

20. The method of claim 19, wherein the second content segment includes a link to a resource external to the second media device, and wherein the processor receives a notification when the link is activated.
